(19) United States
(12) Patent Application Publication
(10) Pub. No.: US 2008/0259941 A1
(43) Pub. Date: Oct. 23, 2008

(54) SYSTEM AND APPARATUS FOR MANAGING IP ADDRESSES

(75) Inventors: YONGDONG ZHAO, PLEASANTON, CA (US); CHOU LAN POK, SAN RAMON, CA (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/737,647

(22) Filed: Apr. 19, 2007

(51) Int. Cl. H04L 12/56

(52) U.S. Cl. 370/401

(57) ABSTRACT

A system and apparatus for managing IP addresses is disclosed. A system that incorporates teachings of the present disclosure may include, for example, a gateway having a controller element to receive a block of IP addresses from a dynamic host configuration protocol server. Additional embodiments are disclosed.

### FIELD OF THE DISCLOSURE

The present disclosure relates generally to communication systems, and more specifically to a system and apparatus for managing IP addresses.

### BACKGROUND

It is common for small businesses to request a block of IP addresses for configuring machines operating in a LAN segment of their business. Often Internet Service Providers (ISPs) use a manual process to assign a block of IP addresses. Maintenance and tracking of blocks of IP addresses can be a cumbersome and error prone task for the ISP and its subscribers. This technique can also give rise to operating issues for the ISP in establishing important security measures for anti spoofing protection for its subscribers.

A need therefore arises for a system and apparatus for managing IP addresses.

### BRIEF DESCRIPTION OF THE DRAWINGS

FIGS. 1 and 2 depict exemplary embodiments of a communication system;

FIG. 3 depicts an exemplary method operating in one or more of the communication systems of FIGS. 1 and 2; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system and apparatus for managing IP addresses.

In a first embodiment of the present disclosure, a computer-readable storage medium in a Dynamic Host Configuration Protocol (DHCP) server can have computer instructions for: receiving from a gateway an identifier; retrieving a block of IP addresses according to the identifier; and transmitting to the gateway an acknowledgment packet with the block of IP addresses.

In a second embodiment of the present disclosure, a gateway can have a controller element to receive a block of IP addresses from a DHCP server.

In a third embodiment of the present disclosure, an access switch of a communication system can have a controller element to monitor an acknowledgment packet directed to a gateway by a Dynamic Host Configuration Protocol (DHCP) server; detects in the acknowledgment packet a field comprising a block of IP addresses; and stores the block of IP addresses to monitor packets transmitted by the gateway.

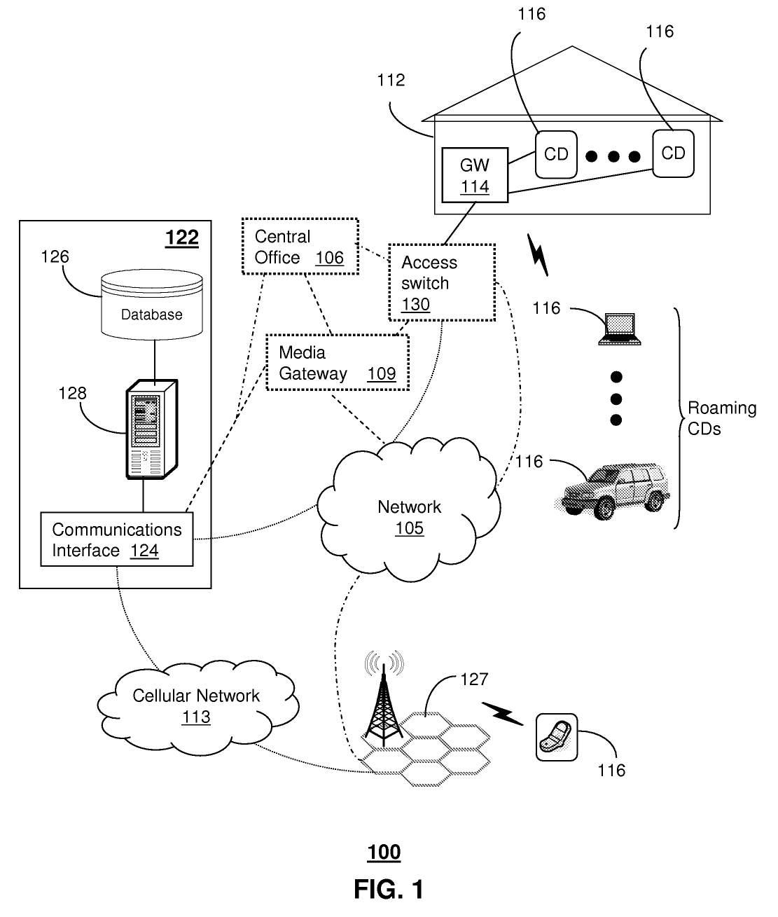

FIG. 1 depicts an exemplary block diagram of a communication system 100 that can supply telecommunication services to one or more fixed and roaming communication devices (CD) 116. The communication devices 116 can include any electronic or network device that is assignable an IP address for communication over the system 100, including VoIP or cellular telephones, computers, set-top boxes, IPTVs, and fax machines, as well as core and peripheral devices including printers, routers, time-servers, and so on. The present disclosure contemplates communication devices 116 including other networked devices as well, such as appliances and the like, that are assignable an IP address and can communicate over the system 100.

The communication system 100 can comprise a central office (CO) 106 coupled to one or more buildings 112. The CO 106 can house common network switching equipment (e.g., circuit-switched and packet-switched switches and routers) for distributing local and long-distance telecommunication services supplied by network 105 to buildings 112 (such as dwellings or commercial enterprises). For illustration purposes only, buildings 112 can be referred to herein as residences 112. However, it should be understood by one of ordinary skill in the art that the buildings 112 can refer to any premises or areas that utilize telecommunication services. Telecommunication services of the CO 106 can include traditional POTS (Plain Old Telephone Service) and broadband services such as HDTV, DSL, VoIP (Voice over Internet Protocol), IPTV (Internet Protocol Television), Internet services, and so on. The communication devices 116 can be portable or fixed, including VoIP, PSTN, and/or cellular terminals, and can provide various media services, such as voice, video and/or data devices.

As a packet-switched network, network 105 can represent an Internet Service Provider (ISP) network. The network 105 can be coupled to a network proxy 122, a cellular network 113 and network elements, such as located in one or more of the buildings 112. As a circuit-switched network, network 105 can provide PSTN services to fixed communication devices 116. In a combined embodiment, network 105 can utilize technology for transporting Internet, voice, and video traffic.

In an enterprise setting, the building 112 can include a gateway 114 that provides voice, video, and/or data connectivity services between communication devices 116, such as VoIP terminals or other forms of network devices of enterprise personnel. In a residential setting, the building 112 can include a gateway 114 represented by, for example, a residential gateway coupled to central office 106, which can utilize conventional telephonic switching for processing calls with third parties.

The network proxy 122 can be used to control operations of a media gateway 109, the central office 106 and/or the gateway 114. Communications between the network proxy 122, the communication devices 116 and other network elements of the communication system 100 can conform to any number of signaling protocols such as a session initiation protocol (SIP), or a video communications protocol, such as H.323 which combines video and voice over a packet-switched network.

The network proxy 122 can comprise a communications interface 124 that utilizes common technology for communicating over an IP interface with the network 105, the media gateway 109, the cellular network 113, and/or the gateway 114. By way of the communications interface 124, the network proxy 122 can direct by common means any of the foregoing network elements to establish packet switched data, voice, and/or video connections between communication devices 116 distributed throughout the communication system 100. The network proxy 122 can further comprise a memory 126 (such as a high capacity storage medium) embodied in this illustration as a database, and a controller 128 that makes use of computing technology such as a desktop computer, or scalable server for controlling operations of the network proxy 122. The network proxy 122 can operate as an IP Multimedia Subsystem (IMS) conforming in part to protocols defined by standards bodies such as 3GPP (Third Generation Partnership Protocol).

Under the control of the network proxy 122, the media gateway 109 can link packet-switched and circuit-switched technologies such as the cellular network 113 (or central office 106) and the network 105, such as an ISP network. The media gateway 109 can conform to a media gateway control protocol (MGCP) also known as H.248 defined by work groups in the Internet Engineering Task Force (WETF). This protocol can handle signaling and session management needed during a multimedia conference. The protocol defines a means of communication which converts data from the format required for a circuit-switched network to that required for a packet-switched network. MGCP can therefore be used to set up, maintain, and terminate calls between multiple disparate network elements of the communication system 100. The media gateway 109 can therefore support hybrid communication environments for communication devices 116, including VoIP terminals.

The cellular network 113 can support voice and data services over a number of access technologies such as GSM-GPRS, EDGE, CDMA-1X, UMTS, WiMAX, software defined radio (SDR), and other known and future technologies. The cellular network 113 can be coupled to base stations 127 under a frequency-reuse plan for communicating over-the-air with roaming VoIP terminals 116.

An access switch 130 can be provided in communication with one or more of the network 105, CO 106, media gateway 109, gateway 114 and network proxy 122. The access switch 130 can include any hardware and telecommunications technology that directs the flow and determines the route of packets as they travel along a portion of the communication system 100, such as to and from the gateway 114. The access switch 130 can be customer premises equipment or can be located otherwise, such as at the CO 106. The access switch 130 can support communication of data, voice and/or video services to and from the gateway 114. In one embodiment, the access switch 130 can perform filtering functions of the packets through use of appropriate hardware and telecommunications technology.

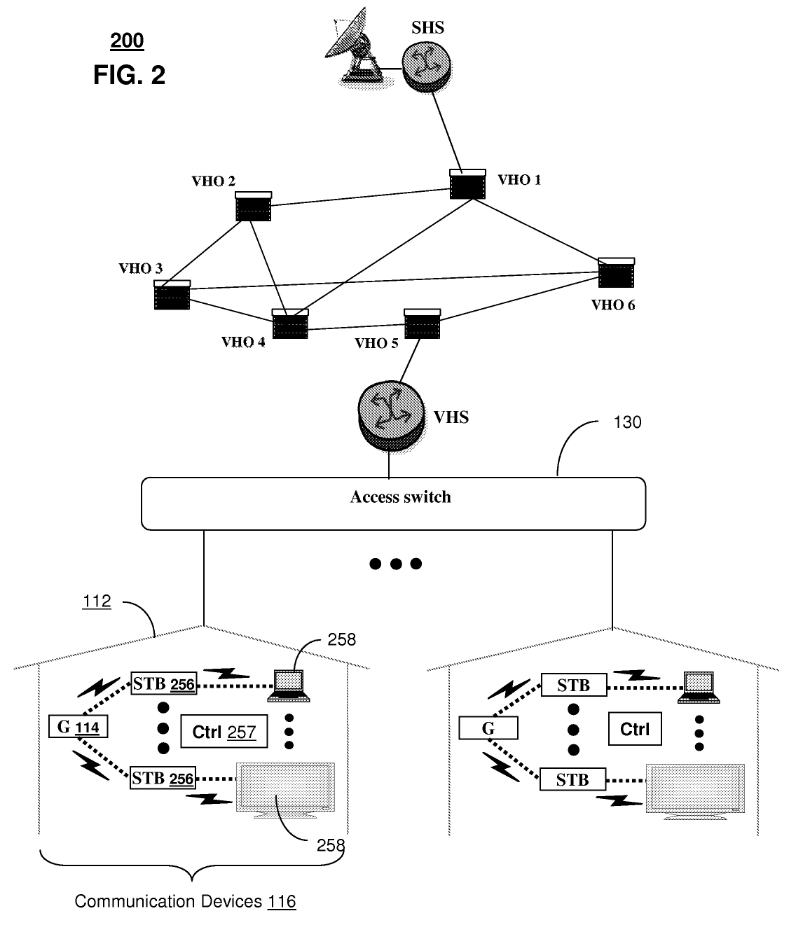

FIG. 2 depicts an exemplary embodiment of a communication system 200 embodying an IPTV service. Communication system 200 can be overlaid or operably coupled with communication system 100 as another representative embodiment of communication system 100. In a typical IPTV backbone, there is at least one super head office server (SHS) which receives national media programs from satellite and/or media servers from service providers of multimedia broadcast channels. The SHS server forwards IP packets associated with the media content to video head servers (VHS) via a network of video head offices (VHO) according to a common multicast communication method. The VHS then distributes multimedia broadcast programs to commercial and/or residential buildings 112 housing the gateway 114 (e.g., a residential gateway or RG) that distributes broadcast signals to receivers such as Set-Top Boxes (STBs) 256 which in turn present broadcast selections or media programs to media devices 258 such as computers or television units managed in some instances by a media controller 257 (e.g., an infrared or RF remote control).

Unicast traffic can also be exchanged between the STBs 256 and the subsystems of the IPTV communication system 200 for services such as video-on-demand (VoD). Although not shown, the aforementioned multimedia system can also be combined with analog broadcast distributions systems.

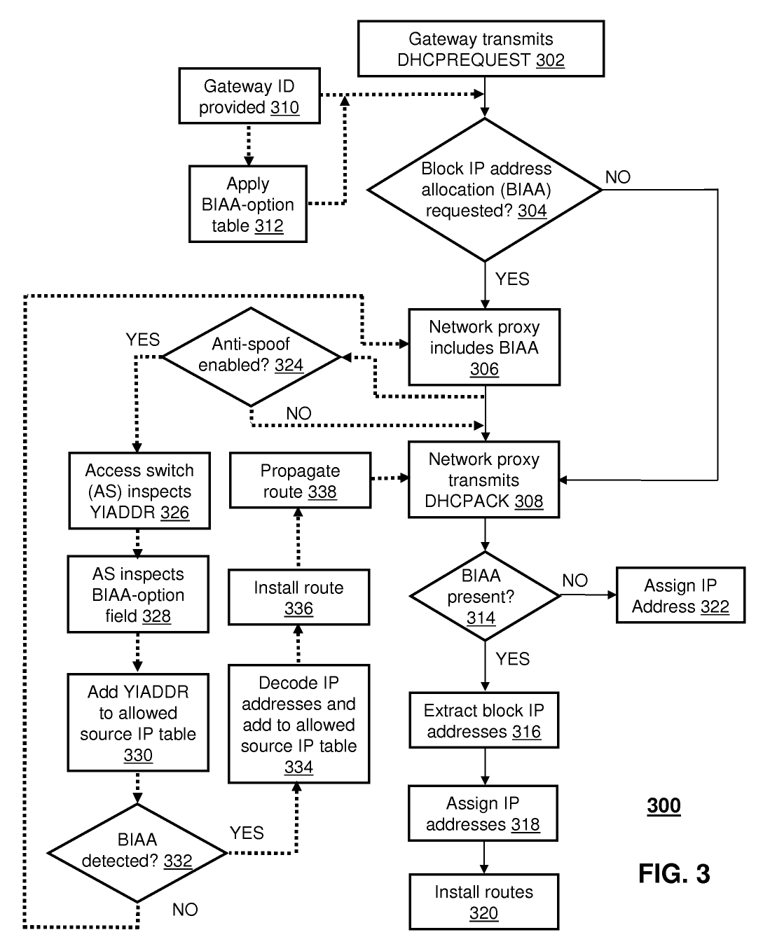

FIG. 3 depicts an exemplary method 300 operating in portions of communication systems 100 and/or 200. Method 300 can begin with step 302 in which a gateway 114 transmits a request to a network proxy 122 for assignment of one or more IP addresses. The request (e.g., DHCPREQUEST packet) can be pursuant to a Dynamic Host Configuration Protocol (DHCP) and can be directed to a DHCP server (e.g., controller 128) of the network proxy 122. The present disclosure contemplates other techniques for communication of the request, including use of a DHCP relay agent for routing request packets to a network that includes a DHCP server. Other communications between the gateway 114 and the network proxy 122 can have occurred prior to the transmission of the request for assignment of IP addresses, including a discover packet (e.g., DHCPDISCOVER packet) where the gateway 114 is broadcasting to determine available servers and an offer packet (e.g., DHCPOFFER packet) where the network proxy 122 is transmitting IP lease information to the gateway, such as lease duration.

The network proxy 122 in step 304 determines whether the gateway 114 is requesting a block of IP addresses to be allocated (BIAA), such as where a DHCPREQUEST packet includes a BIAA-option field. If a BIAA request has been made then in step 306 the network proxy 122 can include a block of IP addresses in an acknowledgement packet. The block of IP addresses can be static and/or dynamic. The network proxy 122 can transmit the acknowledgement packet (e.g., DHCPACK packet) to the gateway 114 in step 308. In addition to the IP address or block of IP addresses, the acknowledgement packet can carry other data to support a network connection, including lease duration and configuration information. In one embodiment, the availability of the IP addresses of the block can be maintained and/or confirmed by other devices or systems other than the DHCP server of the network proxy 122.

In one embodiment, the gateway 114 can transmit an identifier to the network proxy 122, such as in the DHCPREQUEST packet, as in step 310. The identifier can be various identification information, such as a Media Access Control (MAC) address or serial number of the gateway 114, or other information including a subscriber username. In another embodiment, the network proxy 122 can query the gateway 114 for its MAC address utilizing an address resolution protocol (ARP) or any other common technique for retrieving the MAC address. The identifier or other identification information of the gateway 114 can be used by the network proxy 122 in determining whether a BIAA request is being made or whether a gateway is eligible for such a request. In yet another embodiment in step 312, the identifier of the gateway 114, or other identification information, can be used with a lookup table or other data depository that allows for mapping the identifier with respect to those gateways that are making or are eligible for a BIAA request.

In step 314, the gateway 114 can determine whether a block of IP addresses has been transmitted in the acknowledgement packet. If the block of IP addresses has been transmitted, then the gateway 114 can process the block to allow for communication over the system 100 and/or 200 for each of the communication devices 116. In step 316, the gateway 114 can extract each of the IP addresses from the acknowledgement packet. In step 318, the gateway 114 can assign the IP addresses to each of the communication devices 116 that it is serving. In step 320, the gateway 114 can install routes in its routing table according to the IP address assignments it has made for each of the communication devices 116. If on the other hand, the gateway 114 determines back in step 314 that a block of IP addresses has not been transmitted in the acknowledgement packet, then the gateway 114 can process the packet for the IP address provided.

In another embodiment, the network proxy 122 can enable filtering, such as an anti-spoofing function, of transmission between the gateway 114 and the network proxy, as in step 324. In one embodiment, the access switch 130 can be used to monitor packets transmitted by the gateway 114. Prior to receipt of the acknowledgement packet by the gateway 114, the access switch 130 in steps 326 and 328 can retrieve data from the acknowledgement packet, including from the YourIPAddress (YIADDR) field and the BIAA-option field. This data can be used to determine and monitor allowable source IP addresses for a particular gateway 114. In one embodiment in step 330, the access switch 130 can insert the IP address from the YIADDR field of the request packet into a table or other data depository of allowable source IP addresses for the particular gateway 114.

In step 332, the access switch 130 can determine whether a block of IP addresses has been transmitted in the acknowledgement packet based upon the data from the BIAA-option field. If the block has been included in the acknowledgement packet then the access switch 130 can decode the IP address block and add each of the IP addresses to the table or other data depository of allowable source IP addresses for the gateway 114, as in step 334. The access switch 130 can use the table or other data depository of allowable source IP addresses associated with the gateway 114 to monitor packets transmitted by the gateway for IP address spoofing, where further propagation of any spoofing packet over the communication system 100 and/or 200 can then be denied, such as by being dropped by an access router. If on the other hand the block of IP addresses has not been included in the acknowledgement packet then the access switch 130 can communicate an error message or the like to the network proxy 122 and return to step 306.

The access switch 130 can install a route pointing to the gateway 114 in step 336 and can propagate the routing information to other routers of the communication system 100 and/or 200 so that these assigned IP addresses are reachable over the network, as in step 338. The acknowledgement packet, including the block of IP addresses, can then be transmitted to the gateway 114 as recited back in step 308 for assignment to each of the communication devices 116 by the gateway.

From the foregoing descriptions, it would be evident to an artisan with ordinary skill in the art that the aforementioned embodiments can be modified, reduced, or enhanced without departing from the scope and spirit of the claims described below. For example, the network proxy 122 can transmit the same block of IP addresses previously used by the gateway 114 in response to the BIAA request from the gateway. The gateway can also utilize a consistent configuration for its communication devices 116, i.e., maintain the previously used assignments and routes. Of course, these assignments and routes can also be changed for various reasons such as where there is a change in equipment (e.g., a change in number of communication devices 116) or where a new configuration is desired. As another example, the IP host address provided by the network proxy 122 in the acknowledgement packet can be independent of the block of IP addresses or can be included therein. The gateway 114 can also request, and the network proxy 122 can provide, multiple blocks of IP addresses, such as where a gateway is servicing multiple sets of communication devices 116, such as for different subscribers.

These are but a few examples of the modifications that can be applied to the present disclosure without departing from the scope of the claims. Accordingly, the reader is directed to the claims for a fuller understanding of the breadth and scope of the present disclosure.

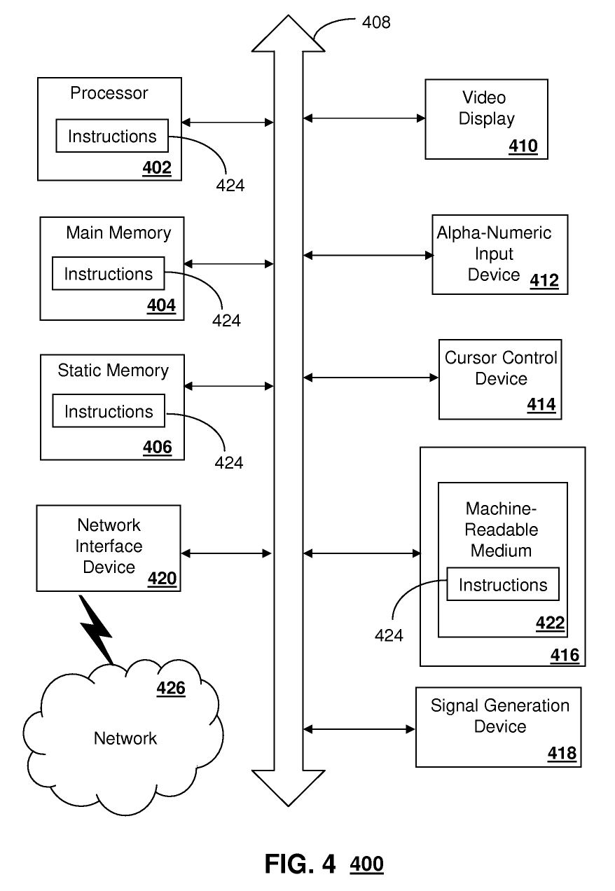

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a mass storage medium 416, a signal generation device 418 (e.g., a speaker or remote control) and a network interface device 420.

The mass storage medium 416 may include a computer-readable storage medium 422 on which is stored one or more sets of instructions (e.g., software 424) embodying any one or more of the methodologies or functions described herein, including those methods illustrated above. The computer-readable storage medium 422 can be an electromechanical medium such as a common disk drive, or a mass storage medium with no moving parts such as Flash or like non-volatile memories. The instructions 424 may also reside, completely or at least partially, within the main memory 404, the static memory 406, and/or within the processor 402 during execution thereof by the computer system 400. The main memory 404 and the processor 402 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the computer-readable storage medium 422 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a Dynamic Host Configuration Protocol (DHCP) server, comprising computer instructions for:
receiving from a gateway an identifier;
retrieving a block of IP addresses according to the identifier; and
transmitting to the gateway an acknowledgment packet with the block of IP addresses.

2. The storage medium of claim 1, wherein the acknowledgment packet corresponds to a DHCPACK packet.

3. The storage medium of claim 2, wherein the DHCPACK packet comprises a field for transmitting the block of IP addresses.

4. The storage medium of claim 1, wherein the block of IP addresses are each static IP addresses.

5. The storage medium of claim 1, wherein the identifier is associated with the gateway.

6. The storage medium of claim 5, wherein the identifier comprises at least one among a Media Access Control (MAC) address of the gateway, and a serial number of the gateway.

7. The storage medium of claim 1, wherein the identifier is associated with a subscriber of the gateway.

8. The storage medium of claim 1, comprising computer instructions for storing the block of IP addresses according to the identifier.

9. The storage medium of claim 1, comprising computer instructions for receiving a request from the gateway for at least one IP address, wherein said request includes the identifier.

10. A gateway, comprising a controller element to receive a block of IP addresses from a Dynamic Host Configuration Protocol (DHCP) server.

11. The gateway of claim 10, wherein the block of IP addresses is received in an acknowledgment packet.

12. The gateway of claim 10, wherein the controller element transmits an identifier to the DHCP server, and wherein the DHCP server retrieves the block of IP addresses according to said identifier.

13. The gateway of claim 12, wherein the identifier is associated with the gateway, and wherein the identifier comprises at least one among a Media Access Control (MAC) address of the gateway, and a serial number of the gateway.

14. The gateway of claim 12, wherein the identifier is associated with a subscriber of the gateway.

15. The gateway of claim 10, wherein the controller element assigns communication devices coupled thereto at least one among the block of IP addresses.

16. The gateway of claim 15, wherein the controller element stores in a routing table the assignment of IP addresses.

17. The gateway of claim 10, wherein the block of IP addresses are each static IP addresses.

18. An access switch of a communication system, comprising a controller element to:
monitor an acknowledgment packet directed to a gateway by a Dynamic Host Configuration Protocol (DHCP) server;
detect in the acknowledgment packet a field comprising a block of IP addresses; and
store the block of IP addresses to monitor packets transmitted by the gateway.

19. The access switch of claim 18, wherein the controller element:
detects a packet transmitted by the gateway; and
validates that a source IP address included in the packet matches one among the block of IP addresses.

20. The access switch of claim 19, wherein the controller element prevents the packet from propagating in the communication system responsive to finding no match between the source IP address of the packet and the block of IP addresses.

21. The access switch of claim 18, wherein the block of IP addresses are each static IP addresses.
